(19) United States
(12) Patent Application Publication
(10) Pub. No.: US 2007/0068029 A1
(43) Pub. Date: Mar. 29, 2007

(54) Control panel of a laundry processing machine

(75) Inventors: Dae Hee Kwon, Busan-si (KR); Hyun Seok Kim, Seoul (KR); Bo Yeon Kim, Changwon-si (KR); Hye Yong Park, Changwon-si (KR); Seong Yeol Lee, Daegu-si (KR)

Correspondence Address: MCKENNA LONG & ALDRIDGE LLP, 1900 K STREET, NW, WASHINGTON, DC, 20006, US

(73) Assignee: LG ELECTRONICS INC., Seoul (KR)

(21) Appl. No.: 11/437,868

(22) Filed: May 22, 2006

(30) Foreign Application Priority Data
May 23, 2005 (KR) 10-2005-43198

(51) Int. Cl. F26B 19/00; H02H 3/00; A47F 3/00; F25D 11/04

(52) U.S. Cl. 34/88; 361/89; 312/114; 62/433

(57) ABSTRACT

The invention of a control panel of a laundry processing machine not only allows control substrate's space efficiency to be increased, by having a LED supporter that possesses control transfer section which has the ability to transfer control commands through buttons, but also has the advantage of allowing the control panels to be smaller and that allows more diverse designs to be materialized.

### BACKGROUND OF THE INVENTION

1. Field of the Invention

This invention relates to the control panel of a laundry processing machine, and more particularly, the control buttons are easily accessible in concord with a limited area so as to allowing the parts of a control panel of a laundry processing machine to be installed compactly, hence enhancing space practicality.

2. Description of the Conventional Art

In general, a laundry processing machine refers to a washing machine which uses water, detergent and mechanical movement to clean stains from clothes or bedding (Referred as ‘Fabric’ onwards), a dryer which uses warm dry wind created by a heater to dry wet fabric and a washer dryer which combines washing and drying in one machine.

FIG. 1 shows a perspective view of a laundry processing machine according to the conventional arts. FIG. 2 shows the disassembled perspective view of a control panel of a laundry processing machine according to the conventional arts. FIG. 3 is a cross-section view of FIG. 1 along with A-A line.

As shown in FIG. 1 to FIG. 3, a laundry processing machine of conventional arts is included a cabinet (2) which creates the exterior, a tub (not shown) that is installed to be able to buffer within the cabinet (2) that carries the water used, a drum (3) that is installed to be rotatable within the tub that holds the laundry, plural lifters (4) that are installed in the drum (3) that lifts and drops laundry using gravity at a specified height, a motor (not shown) at is installed on the back of the tub and generate the power of rotation of the drum (3), a cabinet cover that has a laundry exit built on the frontal part of the cabinet (2) that allows washing to enter and exit, a door (6) that seals laundry exit (4) to allow the cabinet cover to be rotated, and a control panel (7) which displays the movement of the machine (1) and also control the movement of a laundry processing machine.

The control panel (7) includes a frontal panel (10) that consists of a transparent window (12), button hole (14), and knob hole (16), control knob (18) installed to be rotatable on the knob hole (16), control buttons (20) installed to be pressable in the button hole (14) of the frontal panel (10), the control substrate (30) comprised of LED (32) and press switch (34), and placed in the rear of the frontal panel (10) with fixed distance intervals, LED supporter (40) installed on the control substrate ((30)) to support the LED (32) and comprised of guide section (42) for direct light from LED (32) to the transparent window (12).

In the frontal panel (10), plural light display holes are made, the transparent window (12) is comprised of a first transparent window (13) that has a transparent body (11) which added onto the part of the light display hole (3) and a second transparent window (19) that is fit onto the other part of the light display hole (3).

On the back of the 1st transparent window, the LED supporter (40) is placed and on the back of the 2nd transparent window, LED and display element (36) which shows letters or numbers is placed.

The control substrate (30) is installed in the interior of the substrate housing (39), and depending on the substrate housing (39), the distance interval of the frontal panel (10) is then fixed.

Meanwhile, the control buttons (20) as shown in FIG. 2 comprises of the 1st control button (21) which is placed between the push switch (34) and the button hole (14) and the 2nd control button (22) assigned its place in specified distance by the button hole (14).

The 1st control button (21) is installed so that pressing is possible in the back and forth direction and the 2nd control button is installed between the push switch (34) and button hole (14) taking the form of a cantilever.

Therefore, as shown in FIG. 3, the 2nd control button (22) comprises of; fixation section (23) which is placed in the rear of a frontal panel and is fixed by the joint element (8); button section (24) which is installed in the button hole of the 2nd transparent window (19); and the connection section ((25)) which protrude backward to link the button section (24) and the fixation section (23) so that the push switch (34) can control the on/off switch.

On the rear of the frontal panel, a protruding joint boss (15) is made so that the fixation section (23) can contract.

The control panel (7) of a laundry processing machine of conventional arts referred to above depends on the button section of 2nd control button ((22)), the control panel will lead to elastic rotation on a pivot around the fixation section (23). Thereafter, the connection section (25) presses the push switch (34)

When the operation of the button section (24) is dismantled, the 2nd control button (22) restores with its elasticity and returns to its original position.

However, the control panel of a laundry processing machine of the conventional arts is structured so that the joint boss (15) is located in the rear part of the frontal panel (10) for it to connect the fixation section (23) of the second control button (22) needs to be protruded above a certain height. The joint boss (15) which is between the frontal panel (10) and control substrate (30) needs to acquire the protruding space causing the problem of an increase in the control panel size.

Moreover, because the button section of the 2nd control button (22) is located at the front of the LED supporter (40), the connection section (25) must be installed in front of the push switch (34) which is separately installed and the LED supporter (40). Hence there is a limit to the installment space but also takes up more installment space because the length of 2nd control button (22) is formed to be long.

### SUMMARY OF THE INVENTION

The present invention originated to solve the mentioned problems and the main purpose of the invention is to minimize the installment space for parts to provide a control panel of a laundry processing machine which is compact and efficient.

To achieve the mentioned purpose of the invention, control panel of a laundry processing machine is characterized by comprising of; a frontal panel with at least one button hole; a control button which is combined with frontal panel to allow for a button hole to be pressed; a control substrate which has LED and on/off switch controlled by a control button and placed on the rear of the frontal panel; a LED supporter that has a control transfer section that transfers operation ability from the control button to the switch and installed to support LED.

The invention is characterized in that the control button is hook-linked to the rear side of the frontal panel.

The invention is characterized in that one of the control button or the frontal panel has protruding hook and on the other has a hook-hole so that it holds the hook in place.

The invention is characterized by comprising of; a fixation section which is linked to the rear of the frontal panel; a contact section which is located in the frontal part of the control transfer section for it to connect; a protruding button section which allows the button holes in the contact section to fit in the button holes; and a connection section that links the fixation section and contact section together.

The connecting section is formed multi-curvedly.

The control button is characterized by linking of the multiple contact sections within the fixation section.

In the LED supporter, the emphasis is put on the formation of the direction section that guides LED light to a specified area.

In the control transfer section, the emphasis is put on the formation of possible push elasticity between the contact section and the switch.

The control transfer section protrudes towards the contact section, and along with it's surrounding, it forms at least one slit-hole.

The control transfer section is characterized by comprising of protrusion section that protrudes towards the contact section and the elasticity section that provides elasticity by linking the protrusion section with the LED supporter.

Control panel of a laundry processing machine of the invention not only allows control substrate's space efficiency to be increased by having a LED supporter that possesses control transfer section which has the ability to transfer control commands through buttons, but also has the advantage of allowing the control panels to be smaller and that allows more diverse designs to be materialized.

Moreover, because the direction section and control transfer section in the LED supporter is installed together, the control button has the advantage of making it possible for all parts, which face with a LED supporter in the frontal panel, to be installed at the same time

Also the control button is hook-combined to the rear of the frontal panel. So not only does the control button have the advantage of having an easy installation process but also has the advantage of being able to install even if there is not enough space between the frontal panel and the control substrate because the joint boss has been removed from the frontal panel.

Also, because plural button sections have been connected to singular fixation sections, the number of hooks and fixation sections has been reduced. Therefore, not only has the structure been simplified, but also the installation process has become easier and the costs have been reduced.

Also, because the connecting section is formed multi-curvedly, when the button section is pressed, the connecting section can not only easily change, but has the advantage of an increased recovery capacity.

### BRIEF DESCRIPTION OF THE DRAWING

FIG. 1 shows the perspective view of the control panel of a laundry processing machine according to the conventional arts.

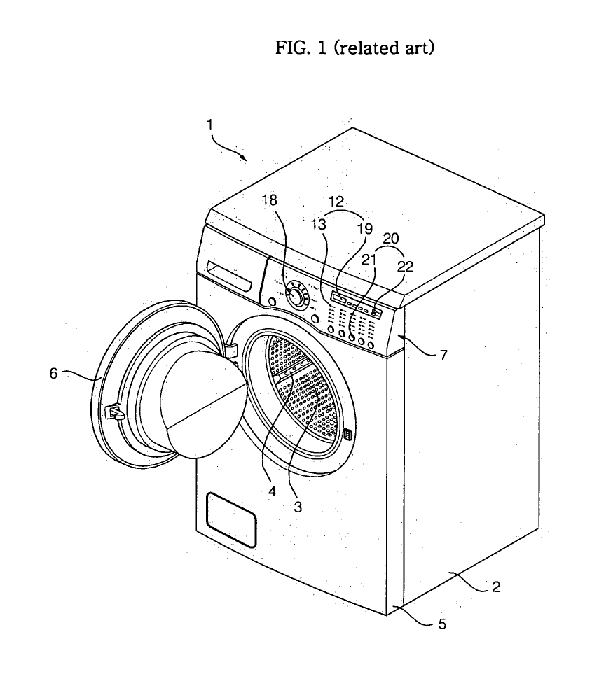

FIG. 2 shows the cross section perspective view of the control panel of a laundry processing machine according to the conventional arts.

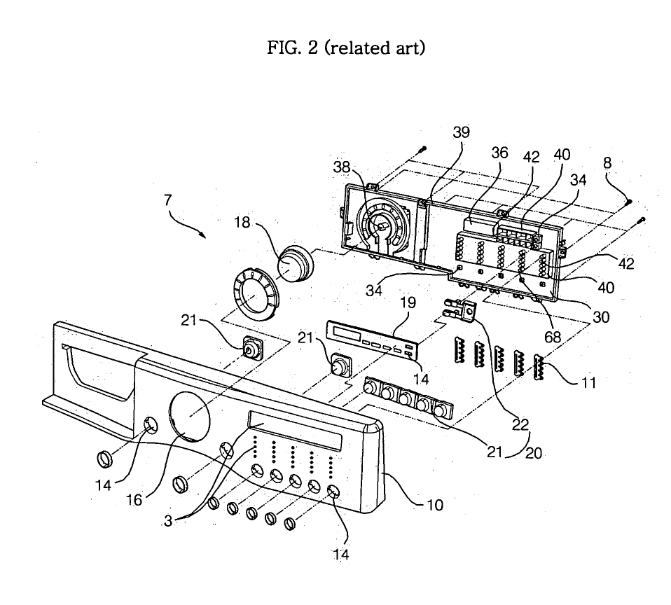

FIG. 3 shows FIG. 1's A-A line sectional diagram.

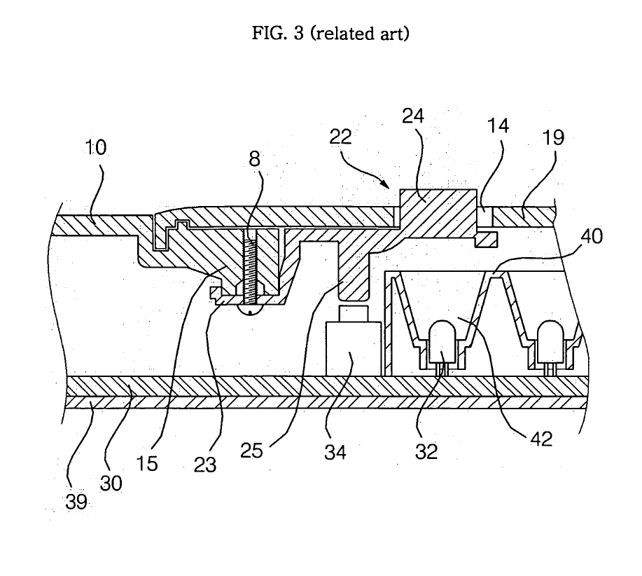

FIG. 4 shows the perspective view of the disassembled control panel of a laundry processing machine according to the embodiment of the invention.

FIG. 5 shows the perspective view of the control panel of a laundry processing machine according to the embodiment of the invention.

FIG. 6 shows the cross section of the principle part of the control panel according to the embodiment of the invention.

FIG. 7 shows the perspective view of the control buttons and supporters disassembled from the control panel according to the embodiment of the invention.

### DETAILED DESCRIPTION OF THE PREFERRED EMBODIMENT

Hereafter, by looking at the attached figures, we may explain the execution examples of the control panel of a laundry processing machine according to the embodiment of the invention.

The control panel of a laundry processing machine in this invention may have several examples, hereafter; only the most appropriate example will be explained. However, conventional formations mentioned above and similar formation factors will have same numbers and addition explanations on those parts will be omitted.

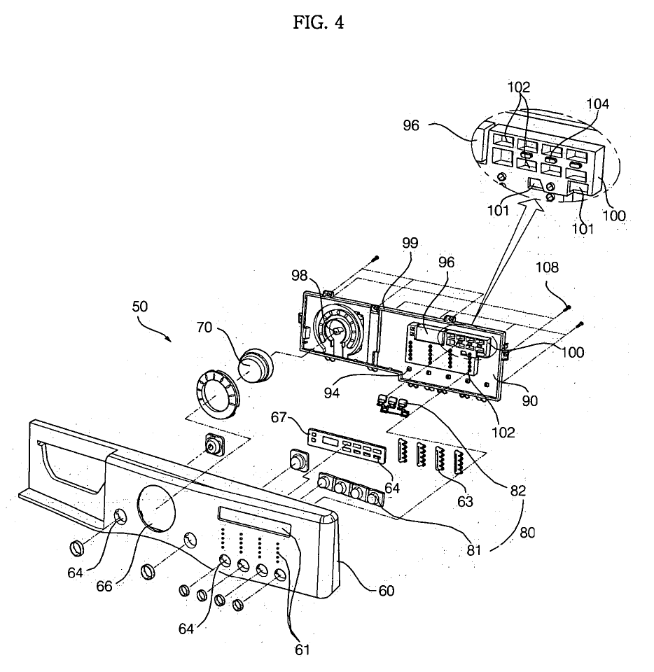

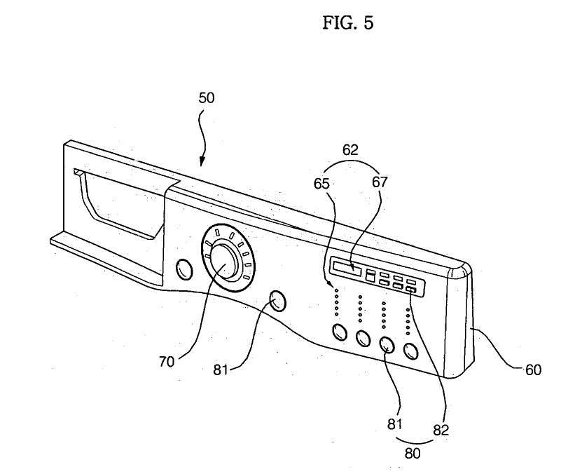

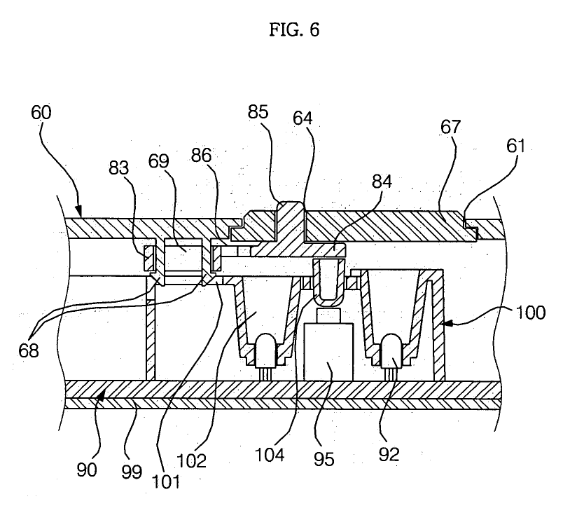

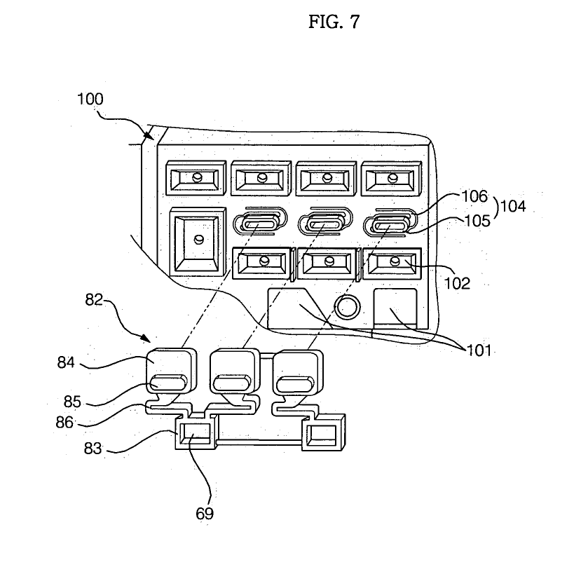

FIG. 4 shows the perspective view of the disassembled control panel of a laundry processing machine according to the embodiment of the invention; FIG. 5 shows the perspective view of the control panel according to the embodiment of the invention, FIG. 6 shows the cross section of the principle part of the control panel according to the embodiment of the invention, and FIG. 7 shows the perspective view of the control buttons and supporters disassembled from the control panel according to the embodiment of the invention.

The control panel of a laundry processing machine of the invention comprises of the following parts and makes up the exterior with a frontal panel (60) that uses at least one of the following; transparent window (62), button hole (64) or knob hole (66). The frontal panel (60) has a control button (80) that allows buttons to be pressed at the button hole (64), a control substrate equipped with a LED (92) and button switch (94, 95) which can be controlled by the control button (80) is placed at the rear of the frontal panel (60), the control substrate (90) supports the LED (92), and a LED supporter (100) that is equipped with a control transfer section (104) that transfers the control passed on from the control button (80) to the button switch (94, 95) are also included in the invention.

Here, the laundry processing machine is selected from a washer, dryer, or a washer-dryer.

Several light display hole (61) are formed on the frontal panel (60), and the transparent window (62) is comprised of the 1st transparent window (65) which is formed while placing 1st transparent elements (63) on parts of the plural light display element (36) holes 61 and the 2nd transparent window (67) which is added on later on the rest of the remaining light display holes (61)

As shown in FIG. 4, the LED supporter (100) is placed on the back of the 1st transparent element (63) and on the back of the 2nd transparent window (67), an display element (96) which indicates numbers or letters and LED (92) are placed.

Also, a knob hole 66 in the frontal panel (60) is equipped with a control knob (70) to allow rotation.

The control substrate ((90)) is placed within the substrate housing (99), and due to the substrate housing (99), a fixed distance is set on the rear end of the frontal panel (60),

In the control substrate (90), a knob switch (98) is placed to counter the control knob (70), and a button switch (94), which is made so that it is possible to press, is placed to counter the control button (80).

The knob, switch (98) which is rotated by the control knob (70), is an encoder that produces various signals depending on the angle of the rotation, and the button switch (94, 95) is an on/off tact switch that operates due to the pressing of the control button (80).

The button switch (94, 95) is comprised of the 1st button switch (94) which is installed separately at a fixed interval place with the LED supporter (100) and the 2nd button switch (95) which is installed within the interior of the LED supporter (100).

On the other hand, the control button (80) is comprised of 1st control button which is located in front of and rear of the 1st button switch (94) so the 1st control button (81) is installed to press the 1st button switch (94) and the 2nd control button (82) that is installed to press the 2nd button switch (95) with a interval distance.

As shown in FIG. 7, the 2nd control button (82) is installed at the rear of the frontal panel and a hook is linked together and in between the button hole (64) and 2nd button switch takes the form of a cantilever.

A protruding hook is formed on either the 2nd control button (82) or the frontal panel (60) and if one side has a hook, the other will form a hook hole. Limitedly speaking, in the example of the invention, a hook was formed on the rear of the frontal panel (60) and a hook hole was formed on the 2nd control button (82).

As displayed in FIG. 6 and FIG. 7, hook hole was formed on the 2nd control button (82), and a fixation section (83) that links to the rear of the frontal panel (60), LED supporter's (100) control transfer section (104) and the contact section (84) located on the frontal part of the control transfer section (104) which links the control transfer section (104), the button section (85) which is-protruded outwards on the contact section (84) to fit in with the button hole (64) and a connecting section (86) that connects the fixation section and contact section make up the components of the 2nd control button (82).

Therefore, the hook hole is formed by a rectangular form on the fixation section (83), a hook (68) has a protruding form on the frontal panel (60) and after the hook is inserted to the hook hole (69), it is formed so that they face so that it can hook onto the surrounding of the fixation section (83).

Also in the LED supporter, to prevent interference after the insertion of the hook 68 into the hook hole (69), a penetration hole (101) is placed on the opposite side of the hook (68) so that the hook (68) can penetrate through.

On the other hand, the button section (85) is inserted into the button hole (64) and to allow protrusion at the front part of the frontal section (60), a predetermined height protrusion at the contact section (84) is formed toward the front in desire.

The contact section (84) is located at the front of the 2nd button switch (95) and to allow easy contact with the 2nd button switch (95), the width is slightly wide.

Also, to make sure the furthest distance is possessed from where the button section (85) is pressed, it is desirable that the contact section (84) is the furthest away from the fixation section (83).

As shown in FIG. 7, the connecting section (86) connects the fixation section (83) and the button section (85) and provide it elasticity, and it is multiple cut between the fixation section (83) and button section (85).

Here, it is possible for the 2nd control button (82) to connect with singular fixation sections (83) and singular contact sections (84) individually, and it is also possible to connect singular number of fixation sections (83) to the plural contact sections (84).

In one hand, the LED supporter (100) supports LED (92) and the 2nd button switch (95) and control substrate (90) is placed at the front, covering both the LED (92) and the 2nd button switch (95) to protect it from an external force.

In the LED supporter, several direction sections are formed to direct LED light, and in between the several direction sections, a control transfer section that transfers controls from the 2nd control button (82) to the 2nd button switch (95) is formed.

The direction section (102) is a conic or quadrangular pyramid shaped protruding passageway toward the rear of the 2nd transparent window (67) that allows light from a LED (92) to move in a specific direction when it is turned on and off by the 2nd button switch (95) without leaking light to other sources.

The control transfer section (104) makes it possible to have elasticity pressing of the buttons between the 2nd button switch (95) and contact section of the 2nd control button (82).

Therefore, as shown in FIG. 7, the control transfer section (104) comprises of the protrusion section (105) which is protruding towards the contact section (84) and the elastic section (106) where it allows the protrusion section (105) and LED supporter (100) to elastically connect together.

The protrusion section (105) is protruded back and forth elongated and has a cylinder form, and the elastic section (106) is formed by cutting slit-hole along with the surrounding of the protrusion section (105).

The slit holes (107) are formed as a spiral along with the circumference of the protrusion section (105). So elastic section (106) also takes on the spiral form.

On the other hand, without being limited in the example, it is possible for a LED supporter (100) that has a control transfer section (104) to be positioned at the back of the 1st control button and a 2nd button switch that counters the control transfer section can also be placed.

Hereafter, the following refers to the formation of the control panel of a laundry processing machine.

First, in an appropriate space on top of a control substrate (90), LED (92), 1st and 2nd button switch (94, 95), display element (96), knob switch (98) are placed and to cover the LED (92) and 2nd button switch (95), a LED supporter (100) is placed on the front part of the control substrate (90).

Here, LED (92) is placed within the direction section (102) of the LED supporter (100) and the 2nd button switch (95) is placed on the lower part of where the control transfer section (104) is located in the LED supporter (100).

As mentioned above, since there is a 2nd button switch (95) as well as a LED (92) located within the LED supporter (100), compared to the conventional arts the parts can be installed on the control substrate (90) more compactly and as the 2nd button switch (95) installment space is specified, the efficiency of the control substrate (90) increases.

When the placements of the parts have been completed like the above, the control substrate (90) is fixed within the substrate housing (99).

Then to counter the light display hole (61), the frontal panel (60) is equipped with the 1st transparent window and the 2nd transparent window.

Then at the knob hole on the frontal panel (60), a control knob (70) is placed so rotation is possible, and at the button hole (64), a control button is placed so that pressing buttons is possible.

Particularly, out of the control button (80), the 2nd control button (82) together with the button section 85 within the button hole (64) within the 2nd transparent window 67, the hook 68 on the rear end of the frontal panel (60) hook-link with the fixation section and the 2nd control button (82) is installed on the rear side of the frontal panel (60) in the form of a cantilever around the fixation section allowing it to rotate freely on a pivot of fixation section (83).

Therefore, the 2nd control button (82) is easily installed to the frontal panel (60) using the hook-connection method, and even if the hook (68) protrusion height is lower than the conventional joint boss and there is no room the 2nd control button will make application possible.

On the rear end of the frontal panel as seen above, substrate housing 99 will become permanently fixed due to the joint boss and the control substrate will be placed at a fixed interval on the back of a frontal panel (60).

Here, the control knob (70) connects with the knob switch (90), and on the back of the 1st transparent element (63), the direction section (102) of LED supporter (100) is placed while the 1st control button 81 is placed in front of the 1st button switch.

Particularly, because the control transfer section (104) and direction section (102) are located on the LED supporter (100) which is positioned on the rear of the 2nd control button (82), the direction section 102 is placed so that it is behind the button section 85 and the control transfer section (104) is located behind the contact section (84).

The hook (68) which is combined on the fixation section (83) of the 2nd control button is protruding at a fixed length backwards at the frontal panel (60) but it is inserted in the penetration hole (101) on the LED supporter (100) so it will not interfere with the LED supporter.

Then, when the frontal panel (60) with the above substrate housing (99) has been placed in front of a laundry processing machine, the control panel assembly is complete.

Hereafter, the following refers to the movement of the control panel of a laundry processing machine.

First, when the user presses the button section (85) of the 2nd control button (82), the button section 85 presses backwards and the contact section 84 moves backwards to press the control transfer section (104).

Here, the button section (85) assembles backwards around the fixation section and due to the connecting section, the button section (85) is able to be pressed smoothly.

When the control transfer section (104) is pressed by the contact section 86, the control transfer section (104) moves backwards and the 2nd button switch (82) is pressed.

Therefore, when the 2nd control button is pressed, the movement of the 2nd control button (82) is transferred on to the 2nd button switch (95) by the control transfer section (104)

Therefore, depending on the 2nd button switch (95) on/off, the specified movement of the laundry processing machine (1) which is controlled by the 2nd button switch (95) can be operated or stopped.

Every time the 2nd button switch (95) turns on and off, the light from the LED (92) flickers, the light of the LED goes to the button section (85) due to the direction section (102) where the button section (85) and button hole (64) made from transparent materials will direct the light to the front part of the frontal panel (60).

Therefore the button section (85) in the 2nd control button executes the same role as the transparent window 62 in the frontal panel (60), and due to the flickering light of the LED (92), the 2nd button switch's (95) on/off function is easily recognized.

On the other hand, if the operation applied by the button section (85) is cancelled, using the elasticity of the connecting section (86), the button section (85) returns to its original position.

Hereafter, the following refers to the effect of the control panel of a laundry processing machine in the above consequences.

As mention above in detail, the above composition of the invention of a control panel of a laundry processing machine not only allows control substrate's space efficiency to be increased, by having a LED supporter that possesses control transfer section which has the ability to transfer control commands through buttons, but also has the advantage of allowing the control panels to be smaller and that allows more diverse designs to be materialized.

Moreover, because the direction section and control transfer section in the LED supporter is created together, the control button has the advantage of making it possible for all parts, which face with a LED supporter in the frontal panel, to be installed at the same time

Also the control button is hook-combined to the rear of the frontal panel. So not only does the control button have the advantage of having an easy installation process but also has the advantage of being able to install even if there is not enough space between the frontal panel and the control substrate because the joint boss has been removed from the frontal panel.

Also, because plural button sections have been connected to singular fixation sections, the number of hooks and fixation sections has been reduced. Therefore, not only has the structure been simplified, but also the installation process has become easier and the costs have been reduced.

Also, because the connecting section is formed by multiple cutting, when the button section is pressed, the connecting section can not only easily change, but has the advantage of an increased recovery capacity.

What is claimed is:

1. A control panel of a laundry processing machine comprising:
a frontal panel with at least one button hole;
a control buttons combined with the frontal panels and pressably installed at the button holes
a control substrate disposed at the rear side of the frontal panel and having an on/off possible switch operated by the control buttons and an LED; and
an LED supporter mounted on the control substrate and having a control transfer section that transfers commands from the control buttons to the on/off possible switch, for supporting the LED.

2. The control panel of a laundry processing machine of claim 1, wherein, the control buttons combined to the rear of the frontal panel with hooks.

3. The control panel of a laundry processing machine of claim 1, wherein, either on the control buttons or the frontal panel, on one side forming a protruding hook and the other a hook hole so that the protruding hooks may be inserted in a control panel for a laundry processing machine.

4. The control panel of a laundry processing machine of claim 1, wherein, the control buttons comprises:
a fixation section combined to the rear of the frontal panel with the hook;
a contact section that has a control transfer section at the front to connect with the control transfer section;
a button section where the contact section can link with the button holes; and
a connecting section connected the contact section with the fixation section.

5. The control panel of a laundry processing machine of claim 4, wherein, the connecting section is formed multi-curvedly.

6. The control panel of a laundry processing machine of claim 4, wherein, the fixation section of the control buttons is combined with the plural contact sections.

7. The control panel of a laundry processing machine of claim 1, wherein, a direction section is disposed on the LED supporter to direct LED light to a specified area.

8. The control panel of a laundry processing machine of claim 1, wherein, the control transfer section is disposed in between the switches and the contact section to be elastically pressed.

9. The control panel of a laundry processing machine of claim 1, wherein, the control transfer section is protruded towards the contact section and formed at least one slit-hole according to the circumference direction.

10. The control panel of a laundry processing machine of claim 1, wherein, the control transfer section comprises a protruding section protruded towards the contact section; and
an elastic section provided elasticity to combine LED supporters with the protruding section.

11. The control panel of a laundry processing machine of claim 10, wherein, the protruding section is formed cylindrically in a control panel for a laundry processing machine.

12. The control panel of a laundry processing machine of claim 10, wherein, one of the elastic section is connected to the protruding section and the other of the elastic section is connected to the LED supporters.

13. The control panel of a laundry processing machine of claim 1, wherein, the switch is disposed among the plural LEDs.

14. The control panel of a laundry processing machine of claim 1, wherein, the control buttons are made from transparent materials.

15. A control panel of a laundry processing machine comprising:
a frontal panel with at least one button hole;
a control buttons is hook-combined with the frontal panels and pressably installed at the button holes;
a control substrate disposed at a rear side of a frontal panel and having an on/off possible switch operated by the control buttons and an LED; and
an LED supporter mounted on the control substrate and having a control transfer section that transfers commands from the control buttons to the on/off possible switch, for supporting the LED,
wherein, the control transfer section is disposed in between the switches and the contact section to be elastically pressed.

16. The control panel of a laundry processing machine of claim 15, wherein, either on the control buttons or frontal panel, on one side forming a protruding hook and the other a hook hole so that the protruding hooks may be inserted in a control panel for a laundry processing machine.

17. The control panel of a laundry processing machine of claim 15, wherein, the control buttons comprises:
a fixation section combined to the rear of the frontal panel with the hook;
a contact section that has a control transfer section at the front to connect with the control transfer section;
a button section where the contact section can link with the button holes; and
a connecting section connected the contact section with the fixation section.

18. The control panel of a laundry processing machine of claim 17, wherein, the control transfer section is protruded towards the contact section and formed at least one slit-hole according to the circumference direction.

19. The control panel of a laundry processing machine of claim 17, wherein, the control transfer section comprises a protruding section protruded towards the contact section;
the elastic section provided elasticity to combine the LED supporters with the protruding section.

20. The control panel of a laundry processing machine of claim 15, wherein, the switch is disposed among the plural LEDs.
